(19) United States
(12) Patent Application Publication
(10) Pub. No.: US 2026/0141500 A1
(43) Pub. Date: May 21, 2026

(54) IMAGE PROCESSING APPARATUS CONFIGURED TO CONTROL DISPLAY OF A HISTORY OF IMAGE PROCESSING

(71) Applicant: CANON KABUSHIKI KAISHA, Tokyo (JP)

(72) Inventors: SHINICHI HAGIWARA, Tokyo (JP); TAKAHIRO SAMPEI, Tokyo (JP)

(21) Appl. No.: 19/316,418

(22) Filed: Sep. 2, 2025

(30) Foreign Application Priority Data
Nov. 15, 2024 (JP) 2024-199532

(51) Int. Cl. G06T 5/92; G06F 3/14

(52) U.S. Cl. CPC G06T 5/92; G06F 3/14; G06T 2207/20208

(57) ABSTRACT

An image processing apparatus sets one of a plurality of image adjustment modes as the adjustment mode, applies image processing to an image based on the set adjustment mode, and displays history information of the image processing applied to the image on a display, wherein if the adjustment mode is switched, an adjustment parameter of at least one image processing applied to the image is changed such that the application of the at least one image processing applied to the image is canceled, and if the adjustment mode is switched, information of the image processing in which the adjustment parameter is changed by the switching of the adjustment mode is displayed on the history information in a distinguishable manner from information of the image processing in which the adjustment parameter is not changed by the switching of the adjustment mode.

### BACKGROUND

### Field of the Technology

The present disclosure relates to an image processing apparatus configured to control display of a history of image processing.

### Description of the Related Art

An environment capable of adjusting and displaying an image in a high dynamic range (hereinafter, referred to as “HDR”) is becoming widespread. Accordingly, a system capable of adjusting and displaying an image suitable for an HDR environment in HDR color gamut has appeared. On the other hand, since a display environment in a standard dynamic range (hereinafter, referred to as “SDR”) in related art is still used, image adjustment and display suitable for an SDR environment are still required. Thus, a system that can switch and execute image adjustment (display) suitable for the SDR environment and image adjustment (display) suitable for the HDR environment has appeared.

In Japanese Patent Laid-Open No. 2020-25178, in a case where adjustment parameters (parameters having different appropriate values in the environments) with which images having different characteristics are obtained between the SDR environment and the HDR environment are adjusted, an information processing apparatus detects that the adjustment parameters need to be re-adjusted. Then, the information processing apparatus notifies a user that the adjustment parameters need to be re-adjusted.

Japanese Patent Laid-Open No. 2020-35294 describes a history display method in which a user displays an adjustment content being applied to an image and an adjustment content not being applied to the image for each editing item in an identifiable manner in an adjustment history.

In a case where the adjustment parameters for obtaining the images having different characteristics between the SDR environment and the HDR environment are adjusted, the adjustment parameters are not reflected when the display environment is switched thereafter. Even when the techniques of Japanese Patent Laid-Open No. 2020-25178 and Japanese Patent Laid-Open No. 2020-35294 are used, when the SDR environment and the HDR environment are switched, the adjustment parameters for obtaining the images having different characteristics between the SDR environment and the HDR environment are not reflected in the image. Thus, even though the user checks a history item after switching the environment, the user cannot appropriately grasp a content of image processing applied to the image.

### SUMMARY

The present disclosure provides a technique that allows a user to more appropriately grasp image processing being applied to an image in a case where an environment (mode) of image adjustment is switched.

The present disclosure its one aspect provides an image processing apparatus configured to operate in accordance with a set adjustment mode, the image processing apparatus including one or more processors and/or circuitry configured to execute mode setting processing of setting one of a plurality of image adjustment modes as the adjustment mode, execute mode reflection processing of applying image processing to an image based on the adjustment mode set by the mode setting processing, and execute display control processing of displaying history information of the image processing applied to the image by the mode reflection processing on a display, wherein in the mode reflection processing, if the adjustment mode is switched, an adjustment parameter of at least one image processing applied to the image is changed such that the application of the at least one image processing applied to the image is canceled, and in the display control processing, if the adjustment mode is switched, information of the image processing in which the adjustment parameter is changed by the switching of the adjustment mode is displayed on the history information in a distinguishable manner from information of the image processing in which the adjustment parameter is not changed by the switching of the adjustment mode.

Features of the present disclosure will become apparent from the following description of embodiments with reference to the attached drawings. The following description of embodiments is described by way of example.

### BRIEF DESCRIPTION OF THE DRAWINGS

FIG. 1 is a hardware configuration diagram of an image processing apparatus.

FIG. 2 is a functional configuration diagram of the image processing apparatus.

FIG. 3 is a diagram for describing a GUI for switching an adjustment mode.

FIG. 4 is a diagram for describing a flow of image adjustment processing.

FIG. 5 is a diagram illustrating an example of an editing history screen.

FIG. 6 is a flowchart of image editing processing.

FIGS. 7A to 7C are diagrams for describing processing of displaying an editing history.

### DESCRIPTION OF THE EMBODIMENTS

Hereinafter, embodiments of the present disclosure will be described with reference to the drawings.

An image processing apparatus according to the present embodiment acquires, for example, a recording file of a RAW image captured by a digital camera. Then, the image processing apparatus develops the RAW image of the recording file (converts the RAW image into an image format visually recognizable by a human). In addition, the image processing apparatus can switch between “image adjustment suitable for an SDR environment” and “image adjustment suitable for an HDR environment” and execute the image adjustment in a procedure of the development processing.

Which one of the image adjustment suitable for the SDR environment and the image adjustment suitable for the HDR environment is performed can be switched by user's selection, for example. Note that, the SDR environment is an environment in which image adjustment or display is performed in a standard dynamic range (SDR). The HDR environment is an environment in which image adjustment or display is performed in a high dynamic range (HDR) having a wider dynamic range than the SDR.

Note that, in the present embodiment, examples of an adjustment mode that can be set in the image processing apparatus include an SDR adjustment mode and an HDR adjustment mode, but the present disclosure is not limited thereto. Setting modes having different image characteristics such as different “color gamut” such as sRGB and AdobeRGB, and different “gamma (gradation conversion characteristic)” such as LOG gamma may be treated as one adjustment mode. For example, in the HDR, setting modes with different characteristics such as HLG and PQ are treated as different adjustment modes.

Here, in the present embodiment, image processing performed by the image processing apparatus will be described separately as “image processing from development processing to gamma processing (γ processing)” and “image processing performed on an image after the image processing”.

The “image processing from development processing to gamma processing (γ processing)” includes image adjustment such as white balance processing, digital gain processing, noise reduction processing, correction processing corresponding to lens characteristics, and correction processing corresponding to a preset imaging mode. In addition, in the γ processing, for example, γ of 1/2.2 is used as gamma characteristics (γ characteristics) particularly suitable for the SDR environment. γ of a perceptual quantization (PQ) system is used, for example, as the γ characteristics suitable for the HDR environment. That is, in the image processing apparatus of the present embodiment, the γ characteristics of 1/2.2 are particularly applied in a case where the image adjustment suitable for the SDR environment is performed, and the γ characteristics of the PQ system are particularly applied in a case where the image adjustment suitable for the HDR environment is performed.

The image processing after the γ processing includes, for example, at least one image adjustment such as RGB tone curve adjustment, color adjustment of eight axes and the like, partial adjustment in the image, copy stamp processing of copying and pasting a region in the image, trimming processing, rotation processing, magnification processing, and the like. In addition, in the image processing apparatus of the present embodiment, at the time of image adjustment, an adjustment parameter voluntarily designated by a user or a separately prepared adjustment parameter set can be used.

Note that, in the following description, the image processing from the development processing to the γ processing is referred to as “first image adjustment”. In addition, the image adjustment performed after the first image adjustment is referred to as “second image adjustment”. Further, in the present embodiment, the adjustment parameter used in the first image adjustment is referred to as a “first adjustment parameter”, and the adjustment parameter used in the second image adjustment is referred to as a “second adjustment parameter”.

The first adjustment parameter includes setting values of “white balance processing, digital gain processing, noise reduction processing, lens characteristic correction processing, preset imaging mode, γ processing, or the like described above”.

The second adjustment parameter includes setting values of “RGB tone curve adjustment, color adjustment of eight axes, partial adjustment, copy stamp processing, trimming processing, rotation processing, magnification processing, or the like described above”.

### Hardware Configuration of Image Processing Apparatus

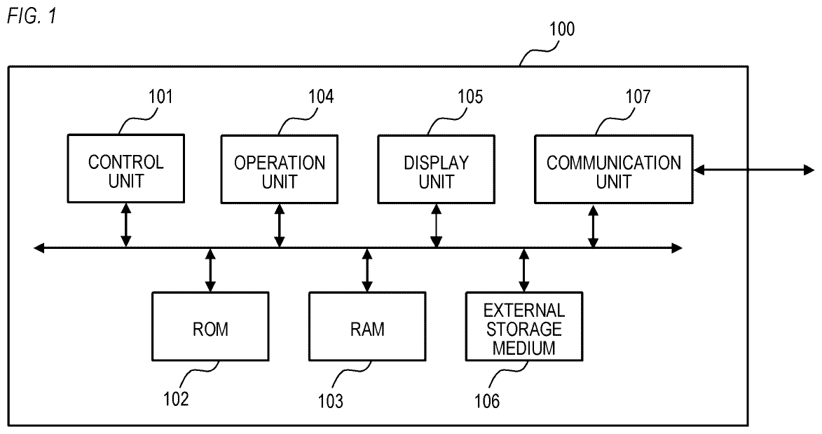

FIG. 1 is a hardware configuration diagram of an image processing apparatus 100 according to the present embodiment. The image processing apparatus 100 includes a control unit 101, a ROM 102, a RAM 103, an operation unit 104, a display unit 105, an external storage medium 106, and a communication unit 107.

The control unit 101 is an arithmetic processing unit (CPU) that controls the entire image processing apparatus 100. In addition, the control unit 101 controls editing processing of an image (image processing) and processing of managing a history of the editing processing (history management processing).

The ROM 102 is a hard disk drive, a solid state drive (SSD), or the like. In the ROM 102, an execution program for the editing processing of the image, digital data such as an encoded image signal, and the like are recorded in a readable format.

A program code and digital data recorded in the ROM 102 are loaded into the RAM 103.

The operation unit 104 includes a keyboard, a mouse, a touch operation unit, or the like. When an input from the operation unit 104 is detected by the control unit 101, processing is performed in accordance with the program loaded in the RAM 103.

The display unit 105 is a cathode ray tube (CRT) display, a liquid crystal panel, or the like. The display unit 105 displays various types of information. In the present embodiment, the operation unit 104 and the display unit 105 are integrally provided as a touch panel.

The external storage medium 106 can save an image and an image editing result generated by applying the editing processing to the image.

The communication unit 107 is an interface for connection to a network line such as the Internet or an interface for communicating with an external device. The communication unit 107 receives an image to be edited.

Note that, the control unit 101 reads an image editing processing application program (hereinafter, referred to as an “image adjustment application”) stored in the ROM 102 or the external storage medium 106, and executes an image adjustment application. Thus, functions and processing of the image processing apparatus 100 are realized.

In addition, the image processing apparatus 100 may be realized by a single computer apparatus. In addition, the image processing apparatus 100 may be realized by a plurality of computer apparatuses executing the functions of the image processing apparatus 100 in a distributed manner as necessary. In a case where the image processing apparatus 100 includes the plurality of computer apparatuses, the plurality of computer apparatuses are connected so as to be able to transmit and receive various types of data and commands to and from each other by communication such as a local area network (LAN).

### Functional Configuration of Image Processing Apparatus

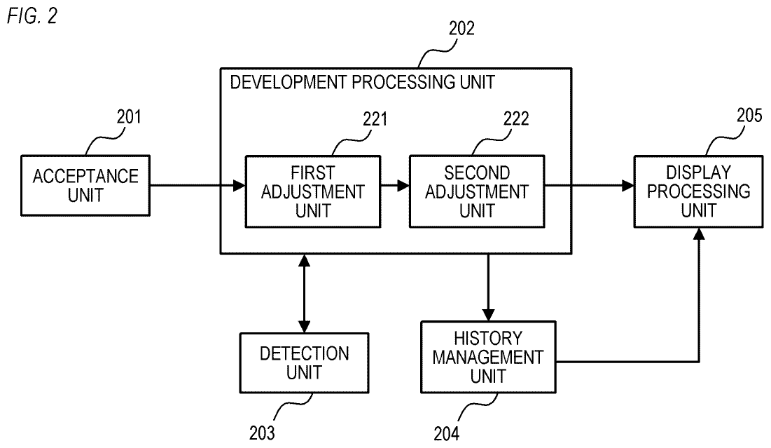

FIG. 2 is a diagram illustrating a functional configuration diagram of the image processing apparatus 100. The image processing apparatus 100 includes an acceptance unit 201, a development processing unit 202, a detection unit 203, a history management unit 204, and a display processing unit 205.

The acceptance unit 201 accepts various instructions corresponding to a user operation. The user performs, for example, an “instruction to switch the adjustment mode”, an “instruction to set the first adjustment parameter to be used in the first image adjustment”, an “instruction to set the second adjustment parameter to be used in the second image adjustment”, and the like via the acceptance unit 201. The instruction from the user is sent to the development processing unit 202 (control unit 101). As a result, for example, the development processing unit 202 controls an operation of the image processing apparatus 100 in accordance with the image adjustment mode selected by the user, and sets each adjustment parameter.

The “instruction to switch the adjustment mode” is an instruction to select one of the image adjustment mode suitable for the SDR environment (hereinafter, referred to as an “SDR image adjustment mode”) and the image adjustment mode suitable for the HDR environment (hereinafter, referred to as an “HDR image adjustment mode”). Details of switching the adjustment mode corresponding to the user operation will be described later.

In addition, in the “instruction to set the first adjustment parameter”, input or selection of setting values of the white balance processing, the digital gain processing, the noise reduction processing, the lens characteristic correction processing, the imaging mode, the γ processing, and the like is performed.

In the “instruction to set the second adjustment parameter”, input or selection of setting values such as the RGB tone curve adjustment, the color adjustment of eight axes or the like, the partial adjustment, the copy stamping, the trimming processing, the rotation processing, and the magnification processing is performed.

The development processing unit 202 operates as an “image processing unit” that performs development processing of an original image (in the first embodiment, RAW image). In addition, the development processing unit 202 also operates as a “mode setting unit” that sets the image adjustment mode selected by the user as the adjustment mode of the image processing apparatus 100. The development processing unit 202 includes a first adjustment unit 221 and a second adjustment unit 222.

The first adjustment unit 221 is a processing unit that executes the first image adjustment corresponding to the adjustment mode (image adjustment mode selected by the user) of the image processing apparatus 100. That is, in a case where the HDR image adjustment mode is selected, the first adjustment unit 221 executes the first image adjustment suitable for the HDR environment. In a case where the SDR image adjustment mode is selected, the first adjustment unit 221 executes the first image adjustment suitable for the SDR environment.

The second adjustment unit 222 is a processing unit that performs the second image adjustment on an image after the first image adjustment by the first adjustment unit 221.

The detection unit 203 determines (detects) whether or not re-adjustment of adjustment parameters to be used for the image adjustment is necessary. In the present embodiment, the detection unit 203 particularly determines whether re-adjustment of the second adjustment parameter applied in the second image adjustment is necessary.

The history management unit 204 manages, as history information, a value (adjustment parameter) of the editing processing such as exposure or white balance in adjustment of a series of development processing, an order in which the editing processing is performed, and the like. The history management unit 204 stores the history information in a predetermined recording region of the external storage medium 106. In addition, the history management unit 204 also records, as the history information, the order in which the editing processing such as rotation and trimming is performed on the RAW image, and an angle and coordinates regarding the rotation and trimming.

The display processing unit 205 is a processing unit (display control unit) that controls display of the history information managed by the history management unit 204, a GUI for selecting the image adjustment mode, and the like. The display processing unit 205 converts an image after the second image adjustment by the second adjustment unit 222 into an image for display. The display processing unit 205 displays the image for display on the display unit 105.

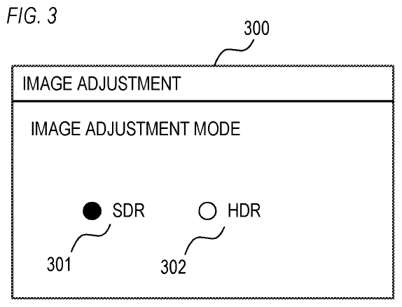

FIG. 3 is a diagram illustrating an example of a graphical user interface (GUI) when the user switches the adjustment mode of the image processing apparatus 100 in the image processing apparatus 100. FIG. 3 illustrates an example of a GUI 300 in a case where one of two modes of the SDR image adjustment mode and the HDR image adjustment mode is performed by selecting an option button (radio button). The GUI 300 is displayed on the display unit 105.

As illustrated in FIG. 3, an option button 301 and an option button 302 are prepared in the GUI 300 for selecting the image adjustment mode. The option button 301 is a button for selecting the SDR image adjustment mode. The option button 302 is a button for selecting the HDR image adjustment mode.

The user can select the adjustment mode by selecting one of the option button 301 and the option button 302 through the operation of the acceptance unit 201. For example, in a case where the option button 301 is selected, the first adjustment unit 221 executes the image adjustment in a state where the adjustment parameter suitable for the SDR environment is set. On the other hand, in a case where the option button 302 is selected, the first adjustment unit 221 executes the image adjustment in a state where adjustment parameters suitable for the HDR environment are set.

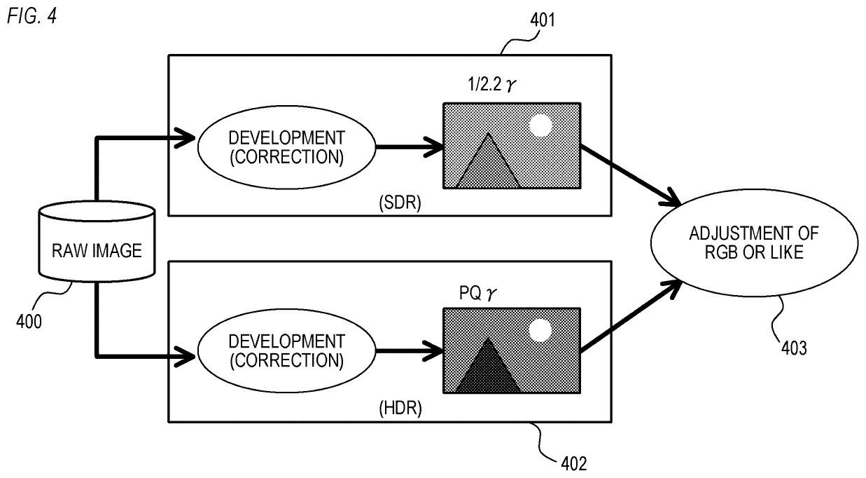

FIG. 4 is a diagram for describing a flow of image adjustment processing corresponding to a selection result of the adjustment mode.

First, a RAW image 400 (recording file) of the original image stored in the ROM 102 or the external storage medium 106 is input to the first adjustment unit 221. Thereafter, in a case where the selected image adjustment mode is the SDR image adjustment mode, the first adjustment unit 221 performs first image adjustment 401 suitable for the SDR environment on the RAW image 400. In the first image adjustment 401, after the development processing and the like, γ processing suitable for SDR display (for example, γ processing using γ characteristics of 1/2.2) is performed.

On the other hand, in a case where the selected image adjustment mode is the HDR image adjustment mode, the first adjustment unit 221 performs first image adjustment 402 suitable for the HDR environment on the RAW image. In the first image adjustment 402, after the development processing and the like, γ processing (for example, γ processing using γ characteristics of the PQ system) suitable for HDR display is performed.

Then, the second adjustment unit 222 performs second image adjustment 403 such as RGB tone curve adjustment on image data after the first image adjustment (the first image adjustment 401 or the first image adjustment 402) by the first adjustment unit 221 is performed.

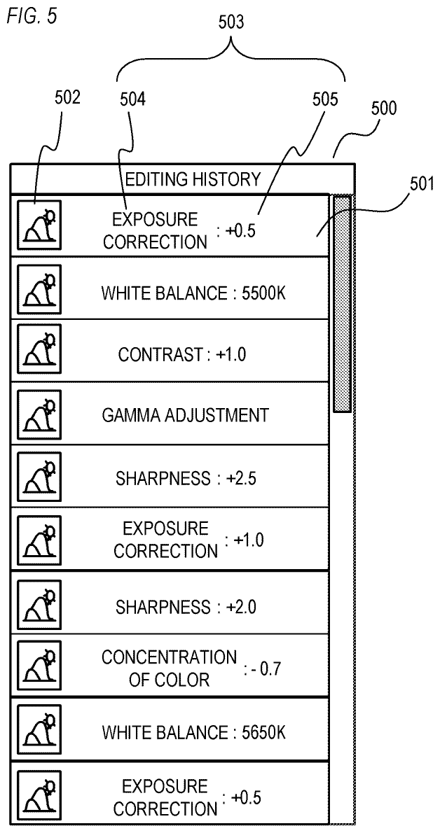

FIG. 5 is a diagram illustrating an example of an editing history screen displayed on the display unit 105.

In an editing history region 500, a plurality of pieces of history information 501 indicating edited contents performed in the past are displayed in chronological order.

The history information 501 includes a thumbnail image 502 of an image after editing and an edited content 503. The edited content 503 includes an editing item 504 indicating what kind of editing processing (image processing) is performed and an adjustment value 505 indicating an adjustment amount (adjustment parameter) of the editing processing. That is, in the editing history region 500, the editing item 504 and the adjustment value 505 in each editing processing are displayed in association with each other.

Further, whenever the editing processing is performed by the development processing unit 202, history information 501 indicating newly performed editing processing (image processing) is added to the editing history region 500. In addition, a series of history information 501 is stored in the external storage medium 106, as one group in association with the RAW image to be edited. Thus, whenever editing processing is newly performed on the RAW image, history information 501 corresponding to the newly performed editing processing is added to a series of groups of history information and stored. Note that, it is also possible to store a plurality of groups in association with one RAW image.

Here, as described above, the image processing apparatus 100 can switch the adjustment mode of the image processing apparatus 100 between the SDR image adjustment mode and the HDR image adjustment mode. The image processing apparatus 100 can also set the adjustment parameters voluntarily designated by the user. As described above, in a case where the adjustment parameters (parameters such as γ characteristic, luminance adjustment value, and color gamut) by which images having different characteristics are obtained in the SDR environment and the HDR environment are adjusted, a content of cancelation of the application to the image when the adjustment mode is switched (image processing; editing processing) occurs. In such a case, there are an “edited content being applied to an image to be processed” (hereinafter, referred to as an “application content”) and an “edited content changed so as to be canceled from application by switching the adjustment mode (hereinafter, referred to as a “non-application content”)” in the editing items displayed in the editing history.

Therefore, the image processing apparatus 100 of the present embodiment displays the application content and the non-application content among the edited contents to which the processing applied to the image is performed such that the user can identify (distinguish) the application content and the non-application content. Specifically, in the editing history display, the image processing apparatus 100 performs highlight display of “history information 501 of the non-application content” and “history information 501 indicating that the adjustment mode is switched” while performing normal display of the history information 501 of the application content.

In the present embodiment, the highlight display is realized by giving a specific icon image (display item) to the history information 501. Note that, an icon image to be given to the history information 501 of the non-application content is different from an icon image to be given to the history information 501 indicating that the adjustment mode is switched.

Note that, the highlight display is not particularly limited as long as the display is a display in a display form that can be identified by the user as being different from the normal display. The normal display and the highlight display may be displayed in different display colors. In addition, colors of characters of the editing item 504 and the adjustment value 505 included in the history information 501 may be different between the normal display and the highlight display.

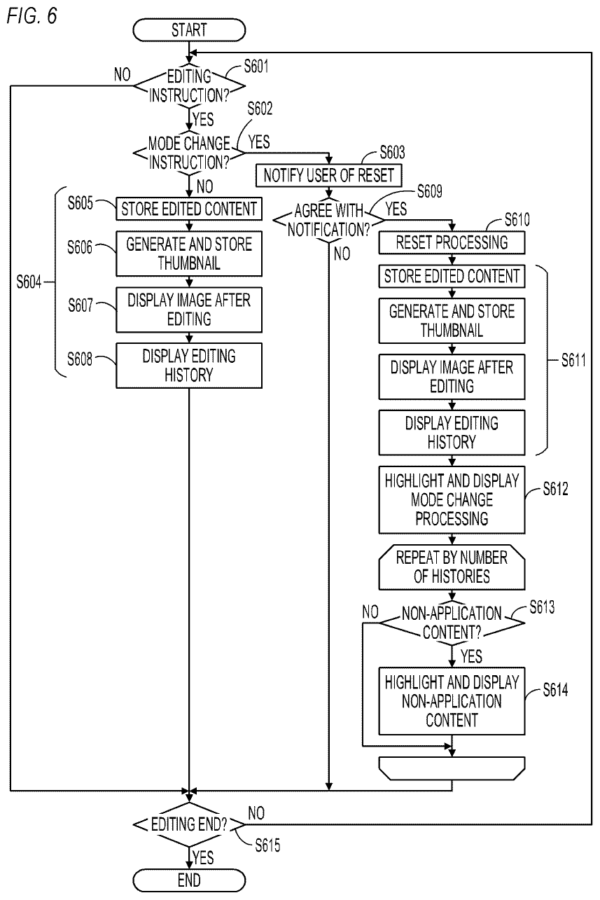

Image editing processing by the image processing apparatus 100 will be described with reference to a flowchart of FIG. 6. Note that, the processing executed in this flowchart is realized by the control unit 101 controlling the configuration illustrated in FIG. 2 according to an operating system (OS) and an image editing application program. When an image editing application is activated, the control unit 101 controls the display unit 105 to display the editing history region 500 (image editing screen). In the editing history region 500 at the time of activation, an image editing result obtained by executing development processing with a predetermined adjustment value on the RAW image to be edited is displayed.

In step S601, the acceptance unit 201 determines whether or not an editing instruction is accepted. For example, when image editing is executed by the user, the acceptance unit 201 accepts an editing instruction. When it is determined that the editing instruction is accepted, the processing proceeds to step S602. In a case where it is determined that the editing instruction is not accepted, the processing proceeds to step S615.

In step S602, the acceptance unit 201 determines whether the accepted editing instruction is an instruction to switch the adjustment mode (mode change instruction). In a case where it is determined that the accepted editing instruction is the mode change instruction, the processing proceeds to step S603. In a case where it is determined that the accepted editing instruction is another editing instruction (editing instruction other than the mode change instruction), the processing proceeds to step S604.

In step S603, the display processing unit 205 explicitly notifies the user that an “edited content that is not reflected and is canceled (reset) in a case where the adjustment mode is switched” occurs. The display processing unit 205 displays, for example, a text message or an icon indicating that the edited content is to be reset. Alternatively, the display processing unit 205 displays a text message, an icon, or the like specifically representing the edited content to be reset.

Step S604 includes step S605 to step S608.

In step S605, the development processing unit 202 performs the editing processing on the image to be processed according to the editing instruction. Then, the history management unit 204 stores the “history information including the edited content related to the editing processing” and the “image after editing” in the external storage medium 106 in association with each other. Here, as illustrated in FIG. 5, the edited content includes an “editing item related to the editing processing” and a “setting value (adjustment value) corresponding to the editing item”. Note that, the image associated with the history information may be an image before editing.

In step S606, the development processing unit 202 generates a thumbnail image from the image after editing. Then, the history management unit 204 associates the thumbnail image (reduced image) with the edited content stored in step S605, adds the history information indicating the edited content to the series of groups of history information, and stores the history information in the external storage medium 106. The thumbnail image generated in step S606 may be an image having a smaller data size than the image after the editing processing.

In step S607, the display processing unit 205 controls the display unit 105 to display the image after the editing processing.

In step S608, the display processing unit 205 displays the editing history in which the edited content and the thumbnail image are associated with each other in the editing history region 500.

In step S609, the acceptance unit 201 accepts a response from the user to the notification displayed in step S603. Then, the acceptance unit 201 determines whether or not the response from the user is a response indicating agreement with the notification (a specific instruction is accepted from the user). In a case where it is determined that the response from the user is the response indicating agreement with the notification, the processing proceeds to step S610. On the other hand, in a case where it is determined that the response from the user is not the response indicating agreement with the notification, the processing proceeds to step S615 without switching the adjustment mode.

In step S610, the development processing unit 202 cancels the association of the editing item reset by switching the adjustment mode with the image performed in step S605. In addition, the development processing unit 202 removes an effect of the image adjustment related to the editing item from a current image (returns to a state before adjustment). That is, the development processing unit 202 changes the adjustment parameters of the image processing so as to cancel (reset) the application of the image processing to the image. For example, the editing item reset by switching the adjustment mode is an item of the image processing related to gamma or color gamut.

Here, the editing item whose application is reset in step S610 will be described. As described above, the image on which the image adjustment suitable for the SDR environment is performed and the image on which the image adjustment suitable for the HDR environment is performed have greatly different characteristics. Thus, for example, when the adjustment parameter is used as it is when the adjustment mode is switched or the adjustment parameter voluntarily designated by the user is set, an image having characteristics different from the characteristics assumed in the image adjustment may be obtained. This is particularly likely to occur in the second image adjustment after the adjustment suitable for the SDR environment or the HDR environment is performed in the first image adjustment.

Therefore, in the present embodiment, for example, the detection unit 203 detects whether or not it is necessary to reset the second adjustment parameter used in the second image adjustment. That is, in a case where the second adjustment parameter is applied to the second adjustment parameter used in the second image adjustment, the detection unit 203 determines whether or not the image having characteristics different from the characteristics assumed by the user can be obtained.

Then, in a case where it is determined that “the second adjustment parameter is an adjustment parameter with which the image having different characteristics is obtained in the SDR display and the HDR display”, the detection unit 203 detects that it is necessary to reset the second adjustment parameter. In this case, the development processing unit 202 executes reset processing. On the other hand, in a case where the detection unit 203 determines that the second adjustment parameter used in the second image adjustment is an adjustment parameter with which an image having different characteristics between the SDR display and the HDR display cannot be obtained, the detection unit detects that it is not necessary to reset the second adjustment parameter. In this case, the development processing unit 202 does not perform the reset processing of the second adjustment parameter.

Note that, in the present embodiment, in step S603, the display processing unit 205 notifies the user of the reset only by determining that the adjustment mode is switched regardless of whether or not the editing item includes an edit content that needs to be reset. However, the display processing unit 205 may determine whether or not the edited content to be actually reset is included in the editing item, and may notify the user of the reset only in a case where the edited content to be reset is included in the editing item.

In step S611, processing similar to that in step S604 is performed. Thus, in step S611, step S605 to step S608 are performed according to a mode change instruction. For example, in step S605, the development processing unit 202 performs processing (mode change processing) of switching the adjustment mode of the image processing apparatus 100 in response to the mode change instruction.

Processing of subsequent step S612 to step S614 is processing of updating a display content of the editing history region 500.

In step S612, the display processing unit 205 highlights the history information 501, which is newly added to the editing history region 500 and indicates the switching of the adjustment mode (mode change processing). As a result, the user can identify at which timing on the editing history the reset edited content is reset.

Next, processing in step S613 and step S614 is processing of performing highlight display such that the reset edited content can be identified. The processing of steps S613 and S614 is repeated by the number of “history information 501 managed by the history management unit 204 and displayed in the editing history region 500”.

In step S613, the history management unit 204 selects, as a processing target, one piece of history information 501 displayed in the editing history region 500. Then, the history management unit 204 determines whether or not the edited content to be processed is the edited content (non-application content) reset by switching the adjustment mode. In a case where it is determined that the edited content to be processed is the non-application content, the processing proceeds to step S614. In a case where it is determined that the edited content to be processed is not the non-application content, the processing of step S613 is performed on next history information 501.

In step S614, the display processing unit 205 highlights the edited content to be processed in the editing history region 500. In the present embodiment, the highlight display is given an icon image to the history information 501. The display processing unit 205 displays the icon image to be given to the history information 501 reset by switching the adjustment mode and the icon image to be given to the history information 501 in which the adjustment mode is switched, with different icons.

In step S615, the acceptance unit 201 determines whether or not an instruction to end the image editing processing is accepted. In a case where it is determined that the end instruction is accepted, the processing (image editing processing) of this flowchart is ended. In a case where it is determined that the end instruction is not accepted, the processing proceeds to step S601.

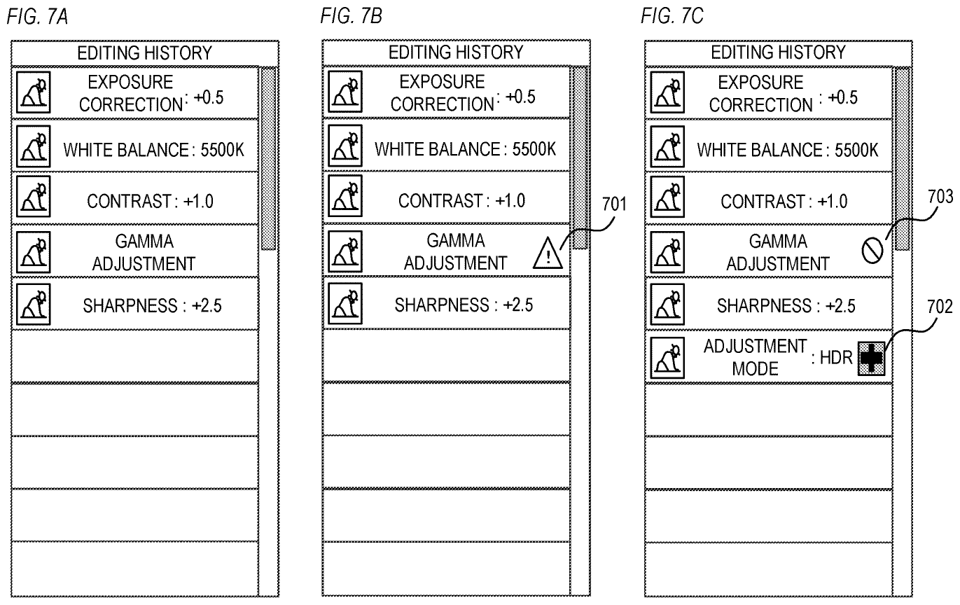

Next, processing of displaying the editing history will be specifically described with reference to FIGS. 7A to 7C. Hereinafter, it is assumed that switching (changing) of the adjustment mode is instructed in a state where various types of editing processing illustrated in FIG. 7A are performed on the image to be processed in accordance with the user operation.

In this case, in step S603 described above, the display processing unit 205 explicitly notifies the user that the “edited content whose application to the image is reset by switching the image adjustment mode (=non-application content)” will be generated. For example, as illustrated in FIG. 7B, an icon 701 is displayed in the history information 501 of the gamma adjustment that is the non-application content. Note that, a text message (not illustrated) indicating that the edited content is reset may be displayed.

FIG. 7C illustrates the editing history region 500 after it is determined in step S609 that the user agrees to the notification and processing in step S610 to step S614 is executed. By the processing in step S612, an icon 702 for notifying the “timing at which the reset occurs in the history information 501 of the adjustment mode” is given to the history information 501 of the adjustment mode. In addition, an icon 703 indicating the history information 501 of the reset edited content is given to the history information 501 of the gamma adjustment by the processing in step S614. The display of the icon 702 and the icon 703 allows the user to identify that the gamma adjustment is reset at the timing of switching the adjustment mode.

Note that, in the present embodiment, the icon 702 and the icon 703 are constantly displayed, but the present disclosure is not limited thereto, and the presence or absence of display may be selectable by a user's operation. Alternatively, only in a case where the history information 501 to which the icon 702 indicating the timing at which the reset occurs is given is brought into a selected state, the icon 703 may be displayed in the history information 501 of the adjustment content reset at that timing.

As described above, according to the present embodiment, even in a case where the adjustment parameters for obtaining the images having different characteristics between the SDR environment and the HDR environment are adjusted, when the SDR environment and the HDR environment are switched, which editing item is being applied can be identified on the history display.

Note that, in the above description, when the editing processing (image processing) in which the application to the image is completely canceled occurs by switching the adjustment mode (that is, the adjustment parameter of the editing processing is changed to 0), the information of the editing processing is highlighted in the editing history region. However, the processing of the present embodiment can be applied not only in a case where the editing processing (image processing) in which the application to the image is completely canceled occurs by switching the adjustment mode, but also in a case where the adjustment parameter of the editing processing is changed. In this case, when the adjustment parameter of at least a part of the editing processing applied to the image is changed by switching the adjustment mode, the information of the editing processing is highlighted. In this case, the display processing unit 205 may also display the information on the amount of changed adjustment parameter in the editing history region. Here, for example, the adjustment mode is switched, and thus, the adjustment parameter of the editing processing related to the color gamut or gamma, applied to the image is changed.

In addition, in the above description, “in a case where A is B or more, the processing proceeds to step S1, and in a case where A is smaller (lower) than B, the processing proceeds to step S2” may be read as “in a case where A is larger (higher) than B, the processing proceeds to step S1, and in a case where A is B or less, the processing proceeds to step S2”. Conversely, “in a case where A is larger (higher) than B, the processing proceeds to step S1, and in a case where A is B or less, the processing proceeds to step S2” may be read as “in a case where A is B or more, the processing proceeds to step S1, and in a case where A is smaller (lower) than B, the processing proceeds to step S2”. Thus, unless a contradiction arises, “A or more” may be read as “larger (higher; longer; more) than A”, and “A or less” may be read as “smaller (lower; shorter; less) than A”. Then, moreover, “larger (higher; longer; more) than A” may be read as “A or more”, and “smaller (lower; shorter; less) than A” may be read as “A or less”.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, in a case where the environment (mode) of the image adjustment is switched, it is possible to cause the user to more appropriately grasp the image processing being applied to the image.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-199532, filed Nov. 15, 2024, which is hereby incorporated by reference herein in its entirety.

What is claimed is:

1. An image processing apparatus configured to operate in accordance with a set adjustment mode, the image processing apparatus comprising:
one or more processors and/or circuitry configured to
execute mode setting processing of setting one of a plurality of image adjustment modes as the adjustment mode,
execute mode reflection processing of applying image processing to an image based on the adjustment mode set by the mode setting processing, and
execute display control processing of displaying history information of the image processing applied to the image by the mode reflection processing on a display, wherein
in the mode reflection processing, if the adjustment mode is switched, an adjustment parameter of at least one image processing applied to the image is changed such that the application of the at least one image processing applied to the image is canceled, and
in the display control processing, if the adjustment mode is switched, information of the image processing in which the adjustment parameter is changed by the switching of the adjustment mode is displayed on the history information in a distinguishable manner from information of the image processing in which the adjustment parameter is not changed by the switching of the adjustment mode.

2. The image processing apparatus according to claim 1,
wherein, in the mode setting processing, the adjustment mode is switched in accordance with a mode change instruction from a user, and
the one or more processors and/or circuitry further executes
notification processing of performing notification indicating that a change occurs in the adjustment parameter of the at least one image processing applied to the image before the adjustment mode is switched in accordance with the mode change instruction.

3. The image processing apparatus according to claim 2, wherein, in the mode setting processing, even in a case where the mode change instruction by the user is given, the adjustment mode is not switched in a case where the user does not give a specific instruction in response to the notification by the notification processing.

4. The image processing apparatus according to claim 3, wherein, in the display control processing, in a case where the mode change instruction by the user is given, the information of the image processing in which the adjustment parameter is changed by the switching of the adjustment mode is highlighted.

5. The image processing apparatus according to claim 1, wherein, in the mode reflection processing, if the adjustment mode is switched, an adjustment parameter of image processing related to a color gamut or gamma, applied to the image is changed.

6. The image processing apparatus according to claim 1,
wherein, in the display control processing, in a case where the adjustment mode is switched,
first highlight display is performed as highlight display of information of the image processing indicating that the adjustment mode is switched, and
second highlight display different from the first highlight display is performed as highlight display of the information of the image processing in which the adjustment parameter is changed by the switching of the adjustment mode.

7. The image processing apparatus according to claim 1, wherein the plurality of image adjustment modes include an image adjustment mode compatible with a standard dynamic range (SDR) and an image adjustment mode compatible with a high dynamic range (HDR).

8. The image processing apparatus according to claim 1, wherein the plurality of image adjustment modes include a plurality of image adjustment modes corresponding to different color gamuts.

9. The image processing apparatus according to claim 1, wherein the plurality of image adjustment modes include a plurality of image adjustment modes corresponding to different gradation conversion characteristics.

10. A control method of an image processing apparatus configured to operate in accordance with a set adjustment mode, the control method comprising:
setting one of a plurality of image adjustment modes as the adjustment mode;
applying image processing to an image based on the set adjustment mode; and
displaying history information of the image processing applied to the image on a display, wherein
if the adjustment mode is switched, an adjustment parameter of at least one image processing applied to the image is changed such that the application of the at least one image processing applied to the image is canceled, and
if the adjustment mode is switched, information of the image processing in which the adjustment parameter is changed by the switching of the adjustment mode is displayed on the history information in a distinguishable manner from information of the image processing in which the adjustment parameter is not changed by the switching of the adjustment mode.

11. A non-transitory computer readable medium that stores a program, wherein the program causes a computer to execute a control method of an image processing apparatus configured to operate in accordance with a set adjustment mode, the control method comprising:
setting one of a plurality of image adjustment modes as the adjustment mode;
applying image processing to an image based on the set adjustment mode; and
displaying history information of the image processing applied to the image on a display, wherein
if the adjustment mode is switched, an adjustment parameter of at least one image processing applied to the image is changed such that the application of the at least one image processing applied to the image is canceled, and
if the adjustment mode is switched, information of the image processing in which the adjustment parameter is changed by the switching of the adjustment mode is displayed on the history information in a distinguishable manner from information of the image processing in which the adjustment parameter is not changed by the switching of the adjustment mode.
